(19) United States
(12) Patent Application Publication
(10) Pub. No.: US 2021/0403229 A1
(43) Pub. Date: Dec. 30, 2021

(54) BLADE SUPPORT APPARATUS

(71) Applicants: Laurie J. Hadley, Clarksville, TN (US); William Wade Hadley, Clarksville, TN (US); Charles Lee Phy, McEwen, TN (US)

(72) Inventors: Laurie J. Hadley, Clarksville, TN (US); William Wade Hadley, Clarksville, TN (US); Charles Lee Phy, McEwen, TN (US)

(21) Appl. No.: 17/469,198

(22) Filed: Sep. 8, 2021

Related U.S. Application Data
(63) Continuation-in-part of application No. 16/584,881, filed on Sep. 26, 2019, now Pat. No. 11,124,109.

(51) Int. Cl. B65D 85/68; B64F 5/50; B60P 7/135

(52) U.S. Cl. CPC B65D 85/68; B64F 5/50; B65D 2585/6882; B65D 2585/687; B60P 7/135

(57) ABSTRACT

The blade support apparatus involves storing and transporting helicopter blades until the blades are needed for reassembly to the helicopter. The blade support apparatus comprises a lid, a container, a root attachment, and a plurality of attachment bars. One end of the helicopter blade is the root. The blade root is secured to the root plug. A multiplicity of supports secure the container to a transport. The height and angle of each blade in the container can be adjusted, enabling them to conform to the blade curvature which spirals from the blade root to the tip of the blade. Height adjustment to a helicopter blade is achieved by a plurality of contoured pads mounted in the container at varying points along the helicopter blade. Angle adjustment is achieved by a plurality of pivot supports mounted in the container at varying points along the helicopter blade.

### CROSS-REFERENCE TO RELATED APPLICATIONS

This application is related to and is a Continuation-In-Part Application to U.S. patent application Ser. No. 16,584,881, entitled “Blade Support Apparatus” (Hadley et al.) filed Sep. 26, 2019, and U.S. Provisional Application No. 62/736,731, entitled “Blade Support Apparatus” (Hadley et al.) filed Sep. 26, 2018.

### FIELD OF THE INVENTION

This invention relates to capturing and stabilizing airfoils such as but not restricted to helicopter airfoils (“blades”) to enable ground transport of aircraft with blade support apparatus including blades in a protective box which may accompany the aircraft. This embodiment enables loading, transport, and unloading of airfoils for transport in a separate blade container which may be stand alone or which can attach to a helicopter transport apparatus. This embodiment of the invention utilizes a support frame which is vertically and radially adjustable. The frame includes a number of contoured padded swivel cradles which can adjust to the height and angle of the profile being captured of the helicopter blades and which protects blades by virtue of a mold which is perfectly contoured to the blades rotating curvature angle along the length of the blade, and which is made of a material which supports and protects the delicate blade. These contoured pads both safely support and protect said helicopter blades during storage or transport. Safe transport is accomplished through a stabilizer which secures container to trailer during transport.

### BACKGROUND INFORMATION

The main rotors of helicopters incorporate a plurality of main rotor blades having large radial dimensions in order to provide the power required to support the flight capabilities of helicopters. These large radial dimensions result in helicopters having structural envelopes that occupy an inordinate amount of space. This increases difficulty of material handling as these blades are fragile and safety in flight is dependent upon their being in perfect order.

Rotorcraft such as, but not limited to, helicopters include a plurality of rotor blades that are used to generate the lift and effectuate the primary flight control of the aircraft. The angle of curvature of the blade twists along the length of each blade. When the rotorcraft is not in use, it can be desired to move or fold the blades of the rotorcraft to a non-flight position. In such a non-flight position, to reduce the footprint of the rotorcraft.

Many manual and automatic blade folding systems have been proposed.
U.S. Pat. No. 7,857,590 (Neal) discloses a folding rotor for a rotorcraft. The folding rotor has a hub bar pivotally connected to a rotor blade. The hub bar is adapted to be connected to the rotorcraft and includes a first locking aperture having a resilient bushing. The rotor blade includes a rotor strap that extends to a mounting element having a second locking aperture. A hinge element connects the hub bar to the mounting element with hinges to enable the rotor blade to pivot with respect to the hub bar between a folded position and an extended position. The first and second locking apertures and the resilient bushing are coaxially aligned when the rotor blade is in the extended position, so that a locking pin may be positioned therethrough to lock the rotor blade in the extended position.
U.S. Pat. No. 6,860,450 (Muylaert, et al.) discloses an apparatus and method for folding helicopter rotor blades for storage and transport. The method comprises providing six helicopters, each helicopter having a fuselage, a main rotor assembly extending out from the fuselage and rotatable about a main rotor axis, and four main rotor blades coupled to the main rotor assembly. The main rotor blades of each helicopter are moveable relative to the main rotor assembly between a deployed position and a stowed position. The deployed position is a position in which the four main rotor blades extend radially from the main rotor. The main rotor blades have a blade rotor diameter of at least forty-seven feet when in the deployed position. The four main rotor blades are coupled to the main rotor assembly when in the stowed position. The method further comprises positioning the six helicopters relative to each other such that all six of the helicopters are simultaneously housed within a parallelepiped region having a height of less than fifteen feet, a width of less than twenty feet, and a length of less than one hundred forty-five feet. The four main rotor blades of each of the six helicopters are in their stowed positions when the six helicopters are simultaneously housed within the parallelepiped region.
U.S. Pat. No. 6,824,151 (Tucei, Jr.) discloses a fixture for transporting helicopter blades. A fixture preferably includes a base, at least two retaining plates, and at least four casters. The base preferably includes two side members, two end members, and at least one cross member. Each retaining plate preferably includes at least one stabilator slot, at least four rotor blade slots, and at least two tail rotor blade slots. Each slot preferably includes a flange member which extends beyond the thickness of the retaining member. A nonabrasive material or nonabrasive coating is applied to an inside surface of each flange member to prevent damage to the helicopter blades.

As will be seen in the subsequent description of the preferred embodiments of the present invention, the present invention overcomes shortcomings of prior art.

Accordingly, there is a clearly felt need in the art for a design and system for transporting helicopter blades or other airfoils safely and securely.

Prior art does not address either the blade contour or the rotation of said contour along the length of blade. The blade curvature spirals from the blade root to the tip of the blade and prior art does not accommodate this variation along the blade.

This invention enables helicopter blades to be loaded, transported and/or stored, and reassembled to the aircraft safely. It is also desirable in many maintenance arenas as removal of blades requires considerable time and specialized personnel for material handling. Prior art typically relies upon a crane for off-loading of the delicate and very lengthy blades. This invention prevents much of the potential damage to blades when handling them with prior art employing a crane and slings. This invention is such that a man standing on the trailer can reach directly up to the main rotor assembly and unpin the blades. Due to the length of the blade this requires two men whether this invention is employed or prior art, however, with this invention the two men simply unpin, loose the root ball from the main rotor assembly, turn and place the entire blade directly into the blade support apparatus. Blade is then locked down and secured and transport happens without further transference of the blade.

A further objective is to provide a means for conveniently supporting the transporting of helicopter blades into storage until blades are needed for reassembly. This blade support apparatus can be removed with blades inside and they go directly into storage without an additional transference of blades.

Other objects, advantages and novel features of the invention will become apparent to those skilled in the art.

### SUMMARY OF THE INVENTION

The blade support apparatus addresses these needs and objectives.

The blade support apparatus captures and stabilizes helicopter blades utilizing a support frame with vertically and radially adjustable supports. These supports have contoured padded cradles and a means of adjusting the height and angle of the cradles to match the profile being captured. These contoured pads both safely support and protect said helicopter blades during storage or transport. Safe transport is accomplished through stabilizer which secures container during transport.

The present invention in the preferred embodiment is a blade support apparatus such as is usable for, but not restricted to, loading, transporting, and/or storing helicopter blades comprises a container with pivoting supports having a platform, the supports including contoured resting pads and a means of adjusting the height and angle of the supports to match the contour of the blade being transported. These adjustment points are independent of each other such that they can be aligned to perfectly match the blade curvature as it changes along the length of each blade.

The blade support apparatus involves storing and transporting helicopter blades until the blades are needed for reassembly to the helicopter. The blade support apparatus comprises a lid, a container, a root attachment, and a plurality of attachment bars. One end of the helicopter blade is the root, which attaches to the helicopter main rotor assembly. The blade root is secured to the root plug. A multiplicity of supports secure the container to a transport. The height and angle of each blade in the container can be adjusted, enabling them to conform to the blade curvature which spirals from the blade root to the tip of the blade. Height adjustment to a helicopter blade is achieved by a plurality of contoured pads mounted in the container at varying points along the helicopter blade. Angle adjustment to a helicopter blade is achieved by a plurality of pivot supports mounted in the container at varying points along the helicopter blade.

The container configuration enables conformity when the blades are removed from the helicopter and put into the blade box container. The root of the blade is secured by placing it onto the root plug and locking it down. The airfoil support pads are contoured pads and together with the pivoting support form a blade cradle which is mounted into the box at varying points. The height and angle can be adjusted for each rotor blade, enabling them to conform to the blade curvature which spirals from the root to the tip of the blade. The need to handle a blade with pitch twisting from the root to the tip of the blade is apparent to those skilled in the art. Therefore, the ability of these cradles to adjust and conform to the varying curvature and pitch of an airfoil is vital to an understanding of this apparatus. Blades are further secured with a Velcro strap (can be other strap) not illustrated for ease of viewing invention. You cannot simply lay the blades on a flat surface which creates point loads. The ability to conform to this spiraling range of motion distributes the load on the blades. This additionally results in a uniform weight distribution on the pads and prevents point loads on the blades.

The container of the present invention must affix firmly to the aircraft transport. A container support, stabilizing block, and stabilizer cap may be utilized for securely connecting the assembly to a helicopter transport apparatus as depicted in U.S. Pat. No. 9,403,559 (Hadley et al.) or U.S. Pat. No. 9,718,390 (Hadley et al.). The blade container may be secured by traditional methods such as welding or bolt-ons but must be stabilized firmly such that the entire vehicle and container are acting along the same plane and securely functioning to the same suspension. i.e. the box cannot be independent or loosely secured to the transport vehicle beneath.

For a complete understanding of the blade support apparatus of the present invention, reference is made to the following detailed description and accompanying drawings in which the presently preferred embodiments of the invention are shown by way of example. As the invention may be embodied in many forms without departing from the spirit or essential characteristics thereof, it is expressly understood that the drawings are for purposes of illustration and description only and are not intended as a definition of the limits of the invention.

### BRIEF DESCRIPTION OF THE DRAWINGS

FIG. 1 depicts a first preferred embodiment of the blade support apparatus of the present invention for capturing and stabilizing airfoils such as helicopter blades to enable ground transport of the helicopter blades in a protective container with the container lid closed.

FIG. 2A depicts the blade support apparatus of FIG. 1 with two blades in position in the protective container.

FIG. 2B depicts the blade support apparatus of FIG. 1 with the two blades removed from the protective container.

FIG. 2C depicts the blade support apparatus of FIG. 2A with four blade capability, with two blades in position in the protective container along with optional support legs.

FIG. 2D depicts the blade support apparatus of FIG. 2C with the four blades removed from the protective container along with optional support legs.

FIG. 3 depicts an exploded view of details from FIGS. 2A and 2B.

FIG. 4A depicts an exploded view of container cradle assembly without airfoil support pads.

FIG. 4B depicts an exploded view of container cradle assembly with airfoil support pads installed and partially pivoted.

FIG. 4C depicts an exploded view of container cradle assembly without airfoil support pads.

FIG. 4D depicts an exploded view of container cradle assembly without airfoil support pads and partially pivoted.

FIG. 5 depicts a trailer transporting the blade support apparatus of FIG. 1.

FIG. 6 depicts an exploded view of a stabilizer assembly for securing a container support of the blade support apparatus of FIG. 1 to the trailer in a way that will protect the container and not damage the helicopter blades during transport.

### DESCRIPTION OF THE PREFERRED EMBODIMENTS

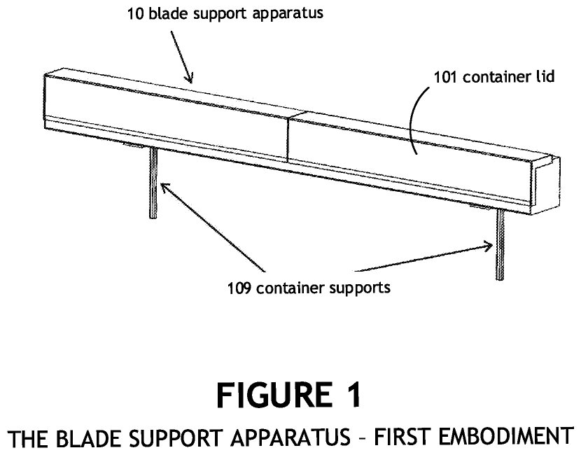

Referring now to the drawings, FIGS. 1 through 6 depict a first preferred embodiment of the blade support apparatus 10 of the present invention, which comprises an elongated blade container 100, a container lid 101, pivoting supports 102, airfoil support pads 103, adjustable supports 104, container cradle mounts 105, root guide channels 106, root locating plugs 107, container supports 109, stabilizing wedge blocks 110, and stabilizer caps 111.

FIG. 1 depicts a first preferred embodiment of the blade support apparatus of the present invention 10 for capturing and stabilizing airfoils such as helicopter blades to enable ground transport. The blade support apparatus of the present invention 10 protects the airfoils (e.g.—helicopter blades 20) in a protective container when the container lid 101 is closed. The blade container 100 has the general shape of an elongated cuboid, with the blade or blades being securely mounted along the elongated plane. Container is affixed to transporter via container supports 109.

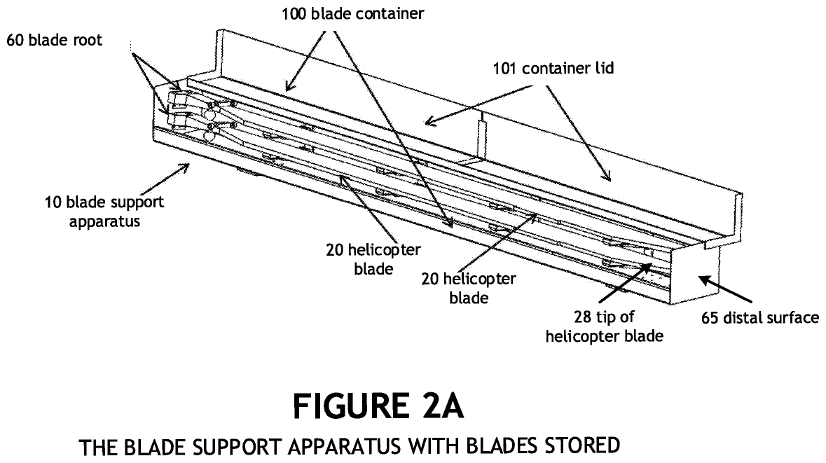

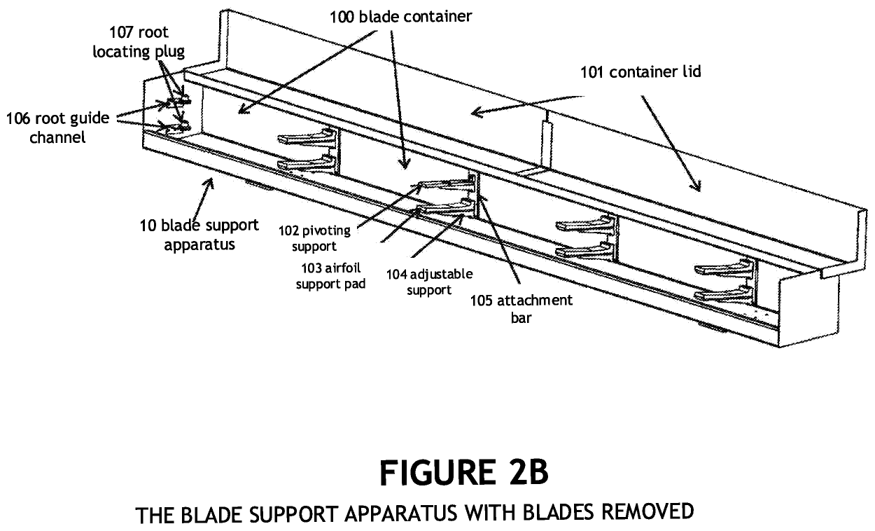

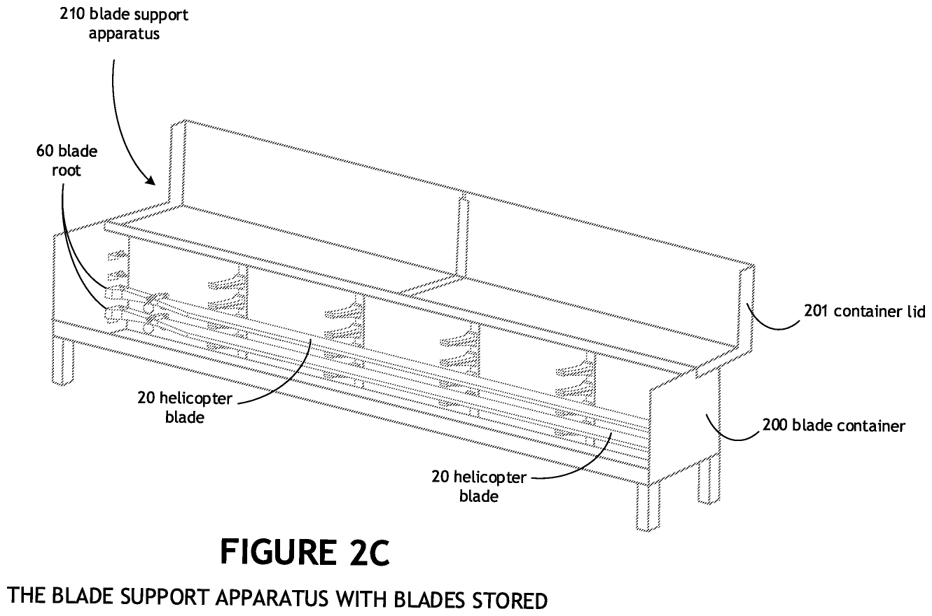

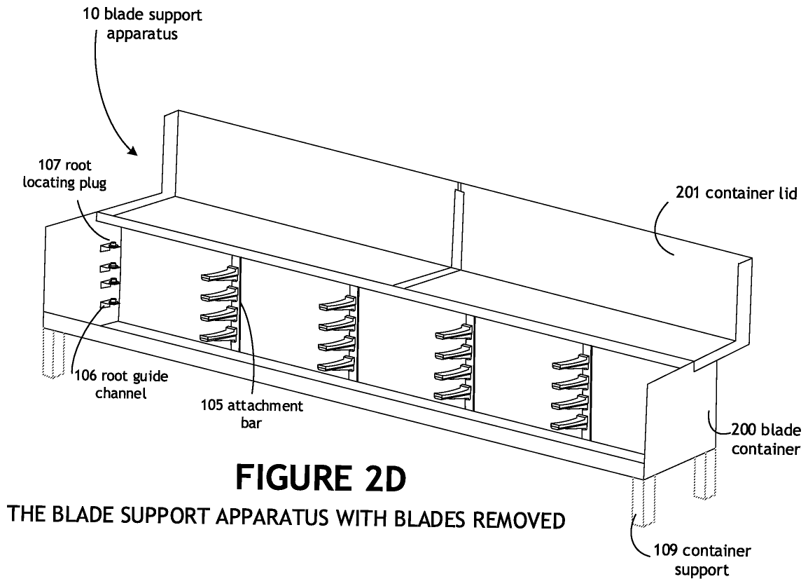

FIG. 2A depicts the blade support apparatus of the present invention 10 with two helicopter blades 20 in position in the protective container 100.

FIG. 2B depicts the blade support apparatus of the present invention 10 with the two blades 20 removed from the protective container 100. The blade container 100 serves to house two helicopter blades 20 and protect the two blades from the outside environment.

FIG. 2C depicts a second preferred embodiment of the blade support apparatus 10 of the present invention 10 with four helicopter blades 20 in position in the protective container 100.

FIG. 2D depicts the blade support apparatus 10 of FIG. 2C with the four blades 20 removed from the protective container 100 along with optional container supports 109.

The blade container 200 serves to house four helicopter blades 20 and protect the four blades from the outside environment.

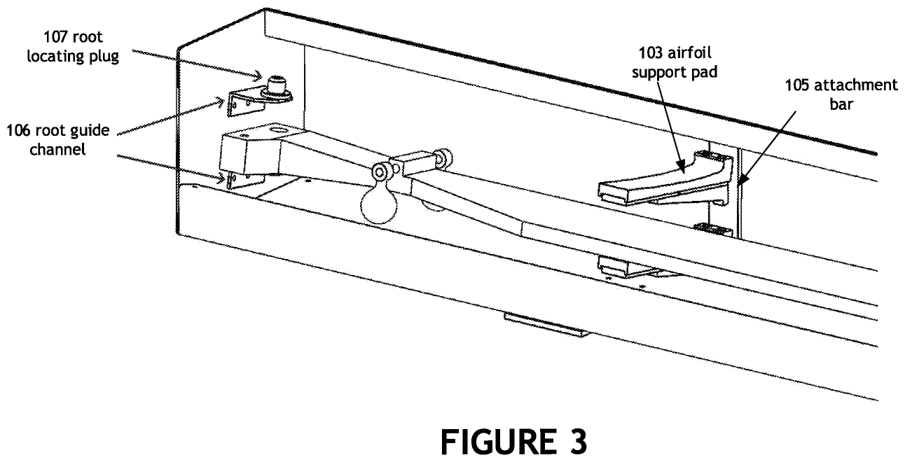

FIG. 3 depicts an exploded view of details from FIGS. 2A and 2B. The pivoting supports 102 with the airfoil support pads 103 along with the root guide channel 106 serve to form a plane on which to support a helicopter blade 20.

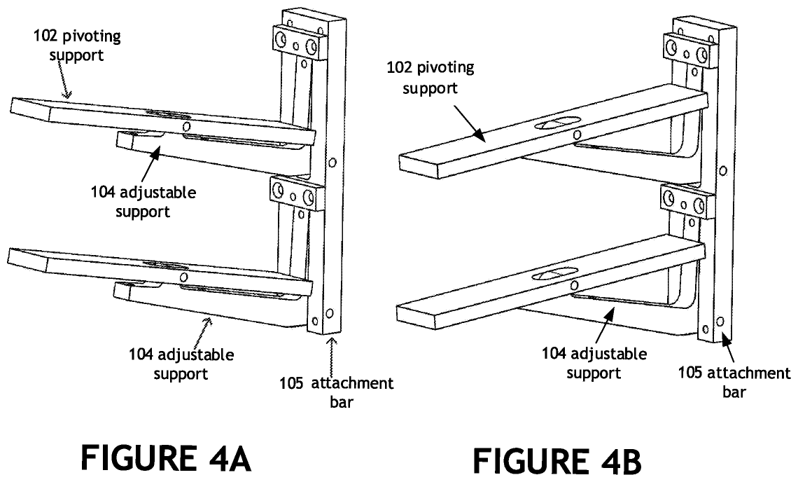

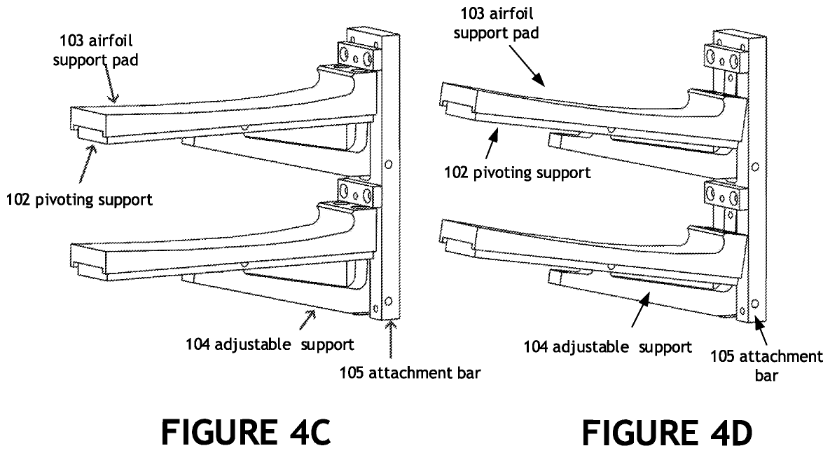

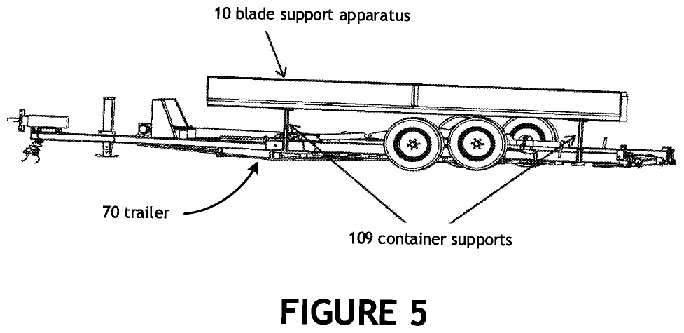

Referring now to FIGS. 4A and 4B, a plurality of attachment bars 105 (four are shown for each blade in FIGS. 2A, 2B, 2C, and 2D) traverse the direction that the helicopter blades 20 are mounted and are preferably vertical and parallel to each other. Generally, the helicopter blades are stored along the elongated surface of the cuboid and are positioned horizontally along the length of the trailer 70. The attachment bars 105 are suspended in vertically (pointed downward) when riding on a smooth, flat, and level surface as depicted in FIG. 5.

Projecting normally for each support bar is a pivoting support 102. Each pivoting support is adjustable relative to each attachment bar 105. Positioned above each pivoting support 102 is an airfoil support pad 103. The surface of the airfoil support pad is cushioned with an airfoil support pad 103 so that the plurality of airfoil support pads absorb any unnecessary stress so that each airfoil blade is cradled within the blade support system of the present invention.

Referring now to FIGS. 4A, 4B, 4C, and 4D, the adjustable supports 104 bolt to slots on container cradle mounts 105, enable height adjustment with fasteners. The pivoting supports 102 pivots on the adjustable supports 104, enabling angular adjustment relative to the attachment bar 105. In addition, slots in the pivoting support 102 enable position adjustment of the airfoil support pads 103. Support pads 103 cradle blades and distribute load across blade width.

The root guide channel 106 and root locating plug 107 serve to locate and support the blade root 60. A root containment screw secures the root in place on the root guide channel 106.

FIG. 5 depicts a trailer 70 for transporting the blade support apparatus of the present invention 10.

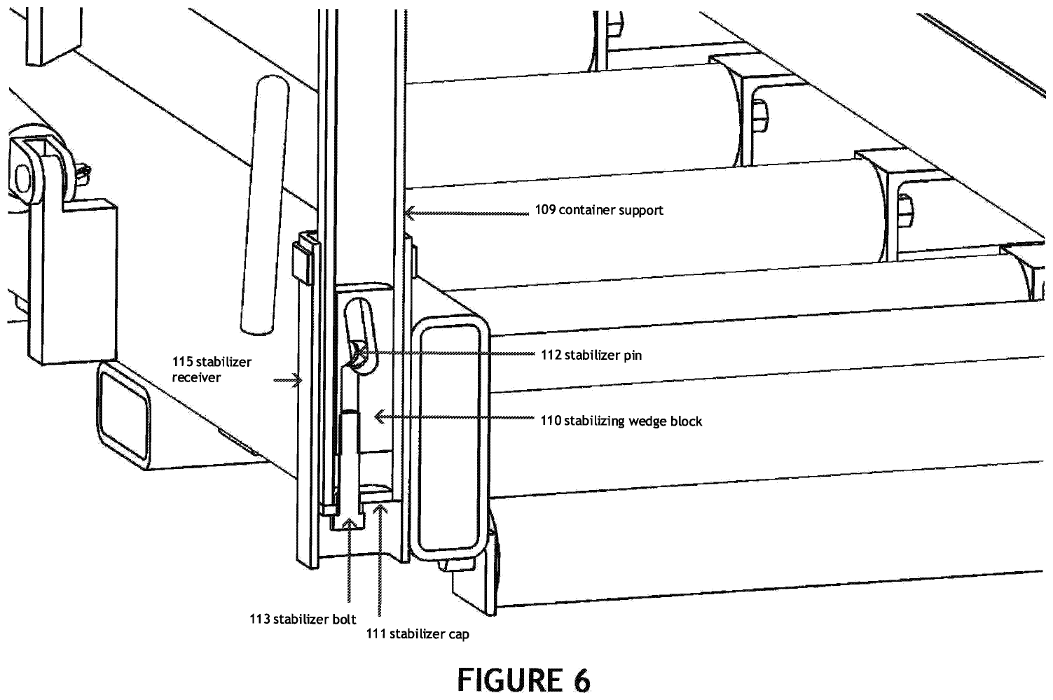

FIG. 6 depicts an exploded view of a stabilizer assembly for securing a container support 109 of the blade support apparatus [10 and 210] to the trailer 70 in a way that will protect the blade support apparatus of the present invention and not damage the helicopter blades 20 during transport.

The vertical support bars are compatible with and preferably attach to a helicopter transport apparatus as depicted in U.S. Pat. No. 9,403,559 (Hadley et al.) or U.S. Pat. No. 9,718,390 (Hadley et al.) using the stabilizing blocks, stabilizer pins (not shown), stabilizer caps, and stabilizer bolts (not shown) (see FIGS. 5, 6A, 6B, and 6C).

In operation, the blade support apparatus 10 is loaded onto a helicopter transport apparatus by placing the container supports 109 in the stabilizer receivers 115 on the apparatus and securing them with stabilizing blocks 110 and stabilizer pins 112. The stabilizer caps 111 are then bolted into the stabilizing blocks 110 from the bottom of the container support 109 to secure the blade support apparatus 10 tightly to the stabilizer receivers 115. The blade support apparatus 10 of the present invention may also be utilized without the container supports 109 but must be secured such that the blade support apparatus is firmly secured to the frame. Other examples would include but are not limited to welding the supports directly to the transport trailer or bolting them to the transport trailer.

The stabilizing wedge block 110 is a wedge. When the bottom bolt 113 is tightened it draws the stabilizing wedge block 110 down. This forces the support bars 109 against the inside of the receiver 115. This drives a wedge between the stabilizer pin 112 and support bar 109. Key benefit of this stabilizing apparatus is to make a rigid connection to the trailer 70. Marrying the blade support apparatus 10 onto the trailer allows the container to have the suspension benefits of the trailer beneath the container. The stabilizing apparatus also allows easy installation and removal of support bars 109. Simply snug in the stabilizing wedge block to install and loosen up stabilizing wedge block 110 to remove. The wedge is at a shallow angle and little force is required to ensure a tight secure fit. It is self-locking and cannot be back-driven.

The helicopter blades 20 are then placed in the open container 100. The first blade 20 is disposed in the lower position. The root locating plug 107 is placed in the blade root 60 with flange on the bottom. The blade root 60 is then guided onto the root guide channel 106 while the blade is carefully placed on airfoil support pads 103 along the same plane. Once the blade is properly seated on all support pads 103 the root containment screw 108 (not shown) is installed to keep the root in place. Next, the blade hold down straps 116 (not shown) are secured to keep the blade in contact with the airfoil support pads 103 and hold the blade 20 in place.

Initial adjustment of the angle, height, and position of each support point is required prior to first use only of the blade support apparatus 10 and is then locked in place for that helicopter blade model. Adjustable support 104 pivots to enable vertical adjustment and pivoting support 102 tilts to enable angular change. Both adjustments are secured with set screws in this preferred embodiment. In addition, airfoil support pad 103 is attached to slots on pivoting support 102, enabling for lateral movement of the pad 103. These features provide a safe, snug custom fit for specific airfoil profiles as varying airfoils have varying tilts and contours. Finally, blade hold down straps 116 (not shown) are fastened to secure blades during transport. The contour pad 103 can be easily swapped out and remolded or reformed for varying airfoil requirements. Additionally, the design is highly and easily adjustable for varying airfoils.

Once the first blade 20 is secured in the lower position, the second blade 20 is loaded using the same procedure. When both the first and second blades 20 are loaded and secured, the container 100 is closed and secured.

As shown, the blade support apparatus 10 of the present invention is made from aluminum and a soft moldable polyurethane. It will also be understood that the blade support apparatus 10 of the present invention and the components can be made from other suitable materials.

In operation, the blade support apparatus 10 of the present invention is installed onto a helicopter transport apparatus by placing the vertical container support bars 109 in the stabilizer receivers 115 on the apparatus and securing them with stabilizing wedge blocks 110 and stabilizer pins 112. The stabilizer caps 111 are then bolted into the stabilizing wedge blocks 110 from the bottom of the vertical container support bar 109 to secure the blade support apparatus 10 of the present invention tightly to the stabilizer receivers 115. This rigid fitment assures that the blades receive the benefit of the suspension provided by the helicopter transfer apparatus. This method is but one means of securing the blade support apparatus 10 to a transport apparatus. There are many other methods which will work.

Although the description of the blade support apparatus 10 of the present invention above includes many specificities, these should not be construed as limiting the scope of the invention but as merely providing illustrations of some of the presently preferred embodiments of this invention.

It is evident that many alternatives, modifications, and variations of the blade support apparatus of the present invention will be apparent to those skilled in the art in lieu of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

Throughout this application, various Patents are referenced by number and inventor. The disclosures of these documents in their entireties are hereby incorporated by reference into this specification in order to more fully describe the state of the art to which this invention pertains. It is evident that many alternatives, modifications, and variations of the blade support apparatus of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10—Blade Support Apparatus
20—Helicopter Blade
28—Tip of Blade
60—Blade Root
65—Distal Surface
70—Trailer
100—Blade Container
101—Container Lid
102—Pivoting Support
103—Airfoil Support Pad
104—Adjustable Support
105—Attachment Bar
106—Root Guide Channel
107—Root Locating Plug
108—Root Containment Screw (not shown)
109—Container Support
110—Stabilizing Wedge Block
111—Stabilizer Cap
112—Stabilizer Pin
113—Stabilizer Bolt
115—Stabilizer Receiver
116—Blade Hold Down Straps (not shown)
200—Blade Container
201—Container Lid
210—Blade Support Apparatus

1. A blade support apparatus for storage and transporting a helicopter blade until said helicopter blade is needed for reassembly, said blade support apparatus comprising:
a lid;
a container having an elongated general shape with two distal surfaces, said container having an open top, said container including a hinge along said open top, said container being in cooperative engagement with said lid whereby said container has an open position and a closed position, said lid closing said open top of said container, said elongated surface having a length that is somewhat larger than a length of said helicopter blade for storage within said container;
a root attachment to one of said two distal surfaces, a root of said helicopter blade being stored in said container being attachable to said root attachment; and
a first root attachment to one of said two distal surfaces, a root to said helicopter blade being stored in said container being attachable to said root attachment for securing said helicopter blade root in place; and
a first attachment bar extending in a direction generally perpendicular to said lid, said first attachment bar including a first pivoting support for adjusting height of said helicopter blade being transported, said first pivoting support including a first airfoil support pad, said first airfoil support pad providing a first swivel cradle for adjusting angle to match a profile of said helicopter blade being transported and for safe support during transport.

2. The blade support apparatus of claim 1, wherein said container has the general shape of an elongated cuboid or parallelopiped.

3. The blade support apparatus of claim 1, further comprising a plurality of container supports, said plurality of container supports securely affixed to a transport for transporting said blade support apparatus.

4. The blade support apparatus of claim 1, further comprising a second attachment bar extending in a direction generally perpendicular to said lid, said second attachment bar including a second pivoting support for adjusting height of said helicopter blade being transported, said second pivoting support including a second airfoil support pad, said second airfoil support pad including a second airfoil pad providing a second swivel cradle for adjusting angle to match a profile of said helicopter blade being transported and for safe support during transport.

5. The blade support apparatus of claim 1, wherein said cradle means includes a plurality of contoured pads mounted in said container at varying points along said helicopter blade and adjusts angle of said helicopter blade within said container.

6. The blade support apparatus of claim 1, wherein said cradle means includes a plurality of pivot supports mounted in said container at varying points along said helicopter blade and adjusts angle of said helicopter blade within said container.

7. A blade support apparatus for storage and transporting a helicopter blade until said helicopter blade is needed for reassembly, said blade support apparatus comprising:
a lid;
a container having an elongated general shape with two distal surfaces, said container having an open top, said container including a hinge along said open top, said container being in cooperative engagement with said lid whereby said container has an open position and a closed position, said lid closing said open top of said container, said elongated surface having a length that is somewhat larger than a length of said helicopter blade for storage within said container;
a root attachment to one of said two distal surfaces, a root to said helicopter blade being stored in said container being attachable to said root attachment for securing said helicopter blade root in place; and
cradle means for adjusting height and angle of said helicopter blade for storage within said container, enabling said helicopter blade support to conform to curvature from said root to a tip of said helicopter bladed and providing safe support during transport

8. The blade support apparatus of claim 7, wherein said container has the general shape of an elongated cuboid or parallelopiped.

9. The blade support apparatus of claim 7, further comprising a plurality of container supports, said plurality of container supports securely affixed to a transport for transporting said blade support apparatus.

10. The blade support apparatus of claim 7, further comprising a second attachment bar extending in a direction generally perpendicular to said lid, said second attachment bar including a second pivoting support for adjusting height of said helicopter blade being transported, said second pivoting support including a second airfoil support pad, said second airfoil support pad including a second airfoil pad providing a second swivel cradle for adjusting angle to match a profile of said helicopter blade being transported.

11. The blade support apparatus of claim 7, wherein said cradle means includes a plurality of contoured pads mounted in said container at varying points along said helicopter blade and adjusts angle of said helicopter blade within said container.

12. The blade support apparatus of claim 7, wherein said cradle means includes a plurality of pivot supports mounted in said container at varying points along said helicopter blade and adjusts angle of said helicopter blade within said container.

13. A blade support apparatus for storage and transporting a plurality of helicopter blades until said plurality of helicopter blades are needed for reassembly, said blade support apparatus comprising:
a lid;
a container having an elongated general shape with two distal surfaces, said container having an open top, said container including a hinge along said open top, said container being in cooperative engagement with said lid whereby said container has an open position and a closed position, said lid closing said open top of said container, said elongated surface having a length that is somewhat larger than a length of said longest helicopter blade being stored within said container;
a first root attachment to one of said two distal surfaces, a second root attachment to same distal surface, a root to a first helicopter blade being stored in said container being attachable to said first root attachment for securing a first helicopter blade root in place, a root to said second helicopter blade being stored in said container being attachable to said second root attachment for securing a second helicopter blade root in place;
a first cradle means for adjusting height and angle and for safe support of said first helicopter blade for storage or transport within said container, said first cradle means enabling said first helicopter blade to conform to curvature from said root to a tip of each of said first helicopter blade; and
a second cradle means for adjusting height and angle and for safe support of said second helicopter blade for storage or transport within said container, said second cradle means enabling said second helicopter blade to conform to curvature from said root to a tip of each of said second helicopter blade.

14. The blade support apparatus of claim 13, further comprising:
a third and fourth root attachment to said same distal surface, a root to said third helicopter blade being stored in said container being attachable to said third root attachment for securing a third helicopter blade root in place, a root to said fourth helicopter blade being stored in said container being attachable to said fourth root attachment for securing a fourth helicopter blade root in place;
a third cradle means for adjusting height and angle and for safe support of said third helicopter blade for storage and transport within said container, said third cradle means enabling said third helicopter blade to conform to curvature from said root to a tip of each of said third helicopter blade; and
a fourth cradle means for adjusting height and angle of said fourth helicopter blade for storage or transport within said container, said fourth cradle means enabling said fourth helicopter blade to conform to curvature from said root to a tip of each of said fourth helicopter blade.

15. The blade support apparatus of claim 13, wherein said container has the general shape of an elongated cuboid or parallelopiped.

16. The blade support apparatus of claim 13, further comprising a plurality of container supports, said plurality of container supports securely affixed to a transport for transporting said blade support apparatus.

17. The blade support apparatus of claim 13, further comprising a second attachment bar extending in a direction generally perpendicular to said lid, said second attachment bar including a second pivoting support for adjusting height of said helicopter blade being transported, said second pivoting support including a second airfoil support pad, said second airfoil support pad including a second airfoil pad providing a second swivel cradle for adjusting angle to match a profile of said helicopter blade being transported.

18. The blade support apparatus of claim 13, wherein said cradle means includes a plurality of contoured pads mounted in said container at varying points along said helicopter blade and adjusts angle of said helicopter blade within said container.

19. The blade support apparatus of claim 13, wherein said cradle means includes a plurality of pivot supports mounted in said container at varying points along said helicopter blade and adjusts angle of said helicopter blade within said container.
